(19) United States
(12) Patent Application Publication
(10) Pub. No.: US 2024/0205920 A1
(43) Pub. Date: Jun. 20, 2024

(54) INTER-UE COORDINATION REQUEST SIGNAL IN VEHICLE-TO-VEHICLE COMMUNICATIONS

(71) Applicant: Kyocera Corporation, Kyoto (JP)

(72) Inventors: Amit KALHAN, San Diego, CA (US); Henry CHANG, San Diego, CA (US); Masato FUJISHIRO, Yokohama (JP)

(21) Appl. No.: 18/287,358

(22) PCT Filed: Apr. 22, 2022
(86) PCT No.: PCT/US2022/025877

§ 371 Date: Oct. 18, 2023

Related U.S. Application Data
(60) Provisional application No. 63/184,651, filed on May 5, 2021.

(51) Int. Cl. H04W 72/20; H04W 4/46

(52) U.S. Cl. CPC H04W 72/20; H04W 4/46

(57) ABSTRACT

The devices, systems, and methods discussed herein involve a first UE device transmitting a request for inter-UE coordination (ICC) information to a second UE device. The request for IUC information is transmitted within a set of physical resources containing control information indicating a Destination Layer 2 identifier (Destination L2 ID) associated with the second UE device. The second CE device transmits the IUC information to the first UE device. The first UE device selects, based at least partially on the IUC information, communication resources to be used for communication with the second UE device.

### CLAIM OF PRIORITY

The present application claims priority to Provisional Application No. 63/184,651, entitled “INTER-UE COORDINATION REQUEST SIGNAL IN VEHICLE-TO-VEHICLE COMMUNICATIONS,” docket number TPRO 00360 US, filed May 5, 2021, which is assigned to the assignee hereof and hereby expressly incorporated by reference in its entirety.

### FIELD

This invention generally relates to wireless communications and more particularly to the exchange of inter-user equipment coordination information between wireless communication devices.

### BACKGROUND

Coordination of information between user equipment (UE) devices facilitates communication between the UE devices.

### SUMMARY

The devices, systems, and methods discussed herein involve a first UE device transmitting a request for inter-UE coordination (IUC) information to a second UE device. The request for IUC information is transmitted within a set of physical resources containing control information indicating a Destination Layer 2 identifier (Destination L2 ID) associated with the second UE device. The second UE device transmits the IUC information to the first UE device. The first UE device selects, based at least partially on the IUC information, communication resources to be used for communication with the second UE device.

### BRIEF DESCRIPTION OF THE DRAWINGS

FIG. 1 is a block diagram of an example of a system in which a first user equipment (UE) device requests inter-UE coordination (IUC) information from a second UE device, where the request is transmitted within a set of physical resources containing control information indicating a Destination Layer 2 identifier (Destination L2 ID) associated with the second UE device.

FIG. 2A is a block diagram of an example of the base station shown in FIG. 1.

FIG. 2B is a block diagram of an example of the user equipment devices shown in FIG. 1.

FIG. 3 is a flowchart of an example of a method in which a first user equipment (UE) device requests inter-UE coordination (IUC) information from a second UE device, where the request is transmitted within a set of physical resources containing control information indicating a Destination Layer 2 identifier (Destination L2 ID) associated with the second UE device.

### DETAILED DESCRIPTION

The examples discussed below are generally directed to vehicle-to-everything (V2X) communication, which is the passing of information from a vehicle to any entity that may affect the vehicle or that the vehicle may affect. For example, V2X is a vehicular communication system that incorporates other, more specific types of communication, including vehicle-to-vehicle (V2V), V21 (vehicle-to-infrastructure), V2N (vehicle-to-network), V2P (vehicle-to-pedestrian), V2D (vehicle-to-device), and V2G (vehicle-to-grid). There are two types of V2X communication technology depending on the underlying technology being used: V2X based on Institute of Electrical and Electronics Engineers 802.11, and cellular-based V2X (C-V2X). Some examples of V2X protocols include Long-Term Evolution (LTE) (Rel-14) V2X Mode 3 and Mode 4 and 5G New Radio (NR) V2X Mode 1 and Mode 2.

In some of the examples described herein, the wireless communication devices are user equipment devices (UEs) or vehicle user equipment devices (VUEs) that exchange data (e.g., in the Extended Sensor use case), which is gathered through local sensors, or live video data among vehicles, Road Side Units (RSUs), devices of pedestrians, and V2X application servers. In some cases, vehicles equipped with an Advanced Driver Assistance System (ADAS) use sensors such as cameras, radar, and/or lidar to sense the neighboring environment and other vehicles.

However, with multiple vehicles transmitting signals within the same general area, data transmission collisions may occur, which may degrade system performance due to unsuccessful signal transmission/reception. Moreover, delayed or failed signal transmissions may also cause safety issues for the vehicles and pedestrians in the area. Thus, it may be advantageous to implement inter-UE coordination (IUC) messaging to enhance Mode 2 resource allocation performance, which reduces the likelihood of data transmission collisions since the UEs can be allocated communication resources that are less likely to interfere with each other.

When considering data transmission collisions, there are two main scenarios. In the first scenario, the collision between two data transmissions has already occurred, and the receiving UEs have detected the collision. The second scenario is when there is a potential for two data transmissions to collide, but the actual data transmissions have not yet occurred. The second scenario happens when two transmitting UEs are unaware of each other and both happen to reserve the same transmission resources for their respective future data transmissions. The first and the second scenarios are referred to as “post-collision” and “potential-collision,” respectively.

In NR V2X, the transmitting UEs are not allowed to reserve their initial transmissions and are half-duplex constrained, meaning they cannot simultaneously transmit and receive signals. As a consequence, in the “post-collision” scenario, two transmitting UEs could accidentally select the same resource or time-slot for their transmissions, causing a data collision. Similarly, a transmitting UE and a receiving UE, which are paired to each other, could accidentally select the same resource or time-slot for their transmissions, which results in an unsuccessful data reception.

The “potential-collision” is a much more challenging scenario. To avoid potential-collisions, the transmit UEs must be able to predict them before the data transmissions occur. The main cause for the potential-collisions is when two transmitting UEs are in a hidden-node situation. A typical hidden-node situation occurs when there is a blockage such that the two transmitting UEs' transmissions are unable to reach each other but still cause interference to each other's respective receiving UEs.

One solution to the hidden-node situation is to support IUC messaging from the receiving UE to inform the transmitting UE of a list of (not-)preferred resources for transmission. However, transmission of the list itself could cause interference. Moreover, this type of coordination only works after the transmission collision between the hidden-nodes has already occurred and been detected.

The devices, systems, and methods discussed herein involve a first UE device transmitting a request for inter-UE coordination (IUC) information to a second UE device. The request for IUC information is transmitted within a set of physical resources containing control information indicating a Destination Layer 2 identifier (Destination L2 ID) associated with the second UE device. The second UE device transmits the IUC information to the first UE device. The first UE device selects, based at least partially on the IUC information, communication resources to be used for communication with the second UE device.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

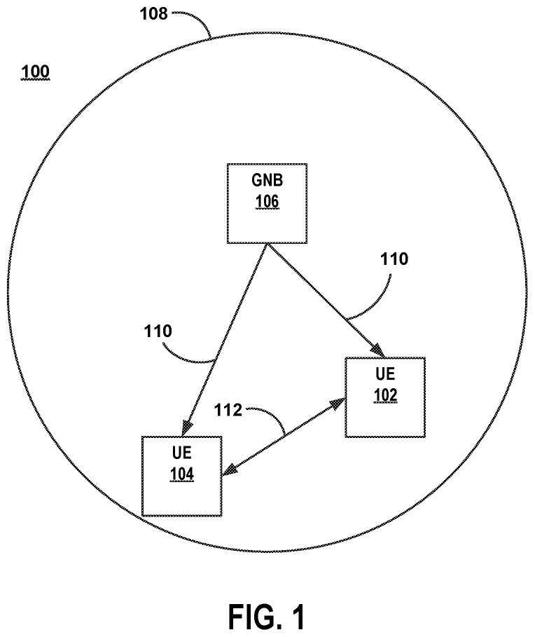

FIG. 1 is a block diagram of an example of a system 100 in which a first user equipment (UE) device requests inter-UE coordination (IUC) information from a second UE device, where the request is transmitted within a set of physical resources containing control information indicating a Destination Layer 2 identifier (Destination L2 ID) associated with the second UE device. The first UE device receives the IUC information from the second UE device and selects communication resources, based at least partially on the IUC information, to be used for communication with the second UE device.

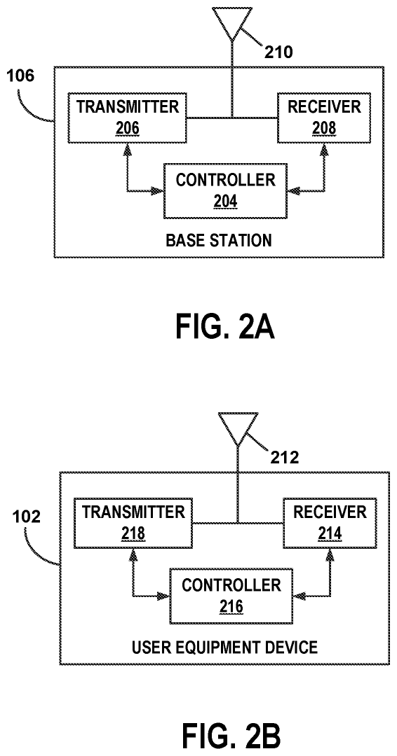

In the interest of brevity, FIG. 1 only depicts first UE device 102 and second UE device 104. However, any number of UE devices may be utilized, in other examples. As shown in FIG. 2B, user equipment device (UE) 102 comprises controller 216, transmitter 218, receiver 214, and antenna 212, as well as other electronics, hardware, and software code. First UE device 102 may also be referred to herein as a first UE or as a first wireless communication device (WCD). UE 102 is wirelessly connected to a radio access network (not shown) via base station 106, which provides various wireless services to UE 102. For the example shown in FIG. 1, UE 102 operates in accordance with at least one revision of the 3rd Generation Partnership Project 5G New Radio (3GPP 5G NR) communication specification. In other examples, UE 102 may operate in accordance with other communication specifications. For the example shown in FIG. 1, both of the UEs have the same components, circuitry, and configuration as UE 102 from FIG. 2B. However, either of the UEs in FIG. 1 may have components, circuitry, and configuration that differ from UE 102, in other examples.

UE 102 is any fixed, mobile, or portable equipment that performs the functions described herein. The various functions and operations of the blocks described with reference to UE 102 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, the transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In the interest of clarity and brevity, only one base station is shown in FIG. 1. However, in other examples, any suitable number of base stations may be utilized. In the example of FIG. 1, base station 106 provides wireless services to UEs within coverage area 108. Although not explicitly shown, coverage area 108 may be comprised of multiple cells. For the example shown in FIG. 1, base station 106, sometimes referred to as a gNodeB or gNB, can receive uplink messages from UE devices and can transmit downlink messages to the UE devices.

Base station 106 is connected to the network through a backhaul (not shown) in accordance with known techniques. As shown in FIG. 2A, base station 106 comprises controller 204, transmitter 206, receiver 208, and antenna 210 as well as other electronics, hardware, and code. Base station 106 is any fixed, mobile, or portable equipment that performs the functions described herein. The various functions and operations of the blocks described with reference to base station 106 may be implemented in any number of devices, circuits, or elements. Two or more of the functional blocks may be integrated in a single device, and the functions described as performed in any single device may be implemented over several devices.

For the example shown in FIG. 2A, base station 106 may be a fixed device or apparatus that is installed at a particular location at the time of system deployment. Examples of such equipment include fixed base stations or fixed transceiver stations. In some situations, base station 106 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 106 may be a portable device that is not fixed to any particular location. Accordingly, base station 106 may be a portable user device such as a UE device in some circumstances.

Controller 204 includes any combination of hardware, software, and/or firmware for executing the functions described herein as well as facilitating the overall functionality of base station 106. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 106 in accordance with one of a plurality of modulation orders.

For the example shown in FIG. 1, base station 106 is capable of broadcasting signals 110 to UE devices within coverage area 108. In some examples, the network can configure UE devices within coverage area 108 via signals 110 broadcast by base station 106. First UE device 102 and second UE device 104 are connected by a sidelink communication link 112, which allows UEs to communicate directly with each other over a direct channel. Other suitable types of communication links may be utilized in system 100, in other examples.

In operation, first UE device 102 transmits, via its transmitter 218 and antenna 212, a request for inter-UE coordination (IUC) information to second UE device 104. However, in some examples, before transmitting the request for IUC information, first UE device 102 requests physical resources from its gNB 106, indicating to gNB 106 that the resource request is associated with a Destination Layer 2 identifier. When first UE device 102 is in a Radio Resource Control (RRC) CONNECTED state relative to gNB 106, first UE device 102 may send an IUC resource request to gNB 106 using an SidelinkUEInformationNR message or an UEAssistanceInformation message, including the Destination Layer 2 Identifier.

For dedicated signaling, first UE device 102 will receive the IUC resource assignment from gNB 106 within an RRCReconfiguration message. Alternatively, when first UE device 102 is in any RRC state, the IUC resources may be configured in SIB12 as a pool of resources, whereby the Destination Layer 2 Identifier may be indicated as a default Destination Layer 2 Identifier that can be mapped to more than one service or more than one user. This means any UE device can use the resource for sending the IUC to a destination UE device that falls within the default Destination Layer 2 Identifier. Since first UE device 102 may be out-of-coverage, the IUC resource may be pre-configured.

In some examples, first UE device 102 transmits the request for IUC information to second UE device 104 within a set of physical resources containing control information indicating a Destination Layer 2 identifier (Destination L2 ID) associated with second UE device 104. For example, the request for IUC information may be transmitted in a Physical Resource Block (PRB) that is mapped to a Destination L2 ID associated with second UE device 104, in some examples. In these examples, receiver 214 of first UE device 102 may be further configured to receive a message containing PRB index assignment information for one or more UE devices, including second UE device 104. Likewise, receiver 214 of first UE device 102 may be further configured, in some examples, to receive a message containing a Destination L2 ID for one or more UE devices, including second UE device 104.

In other examples, first UE device 102 includes the Destination L2 ID associated with second UE device 104 in an upper layer (e.g., Application Layer) message. Thus, in some examples, the Destination L2 ID may not be encoded directly within the Sidelink Control Information (SCI).

In some examples, the request for IUC information comprises a 1-bit signal. In other examples, the request for IUC information comprises a signal comprising a plurality of bits.

In some examples, the request for IUC information is transmitted utilizing a set of communication resources dedicated to transmit requests for IUC information. In other examples, the request for IUC information is transmitted over a Physical Sidelink Feedback Channel (PSFCH).

In further examples, the request for IUC information is transmitted at least an integer number of slots before first UE device 102 intends to send a data transmission to second UE device 104. In some examples, first UE device 102 receives, via its antenna 212 and receiver 214, the integer number from a network (e.g., via signal 110 sent from base station 106).

Second UE device 104 receives, via its antenna 212 and receiver 214, the request for IUC information. In response to the request, second UE device 104 prepares IUC information. In some examples, the prepared IUC information includes one or more of the following: a list of preferred communication resources, a list of non-preferred communication resources, an indication of expected/potential and/or detected resource conflicts on the resources indicated by the SCI of first UE device 102, and a potential/detected hidden-node situation, as mentioned above. In other examples, the prepared IUC information may include any information that facilitates direct communication between first UE device 102 and second UE device 104.

Regardless of the exact contents of the IUC information, second UE device 104 transmits, via its transmitter 218 and antenna 212, the IUC information to first UE device 102. First UE device 102 receives the IUC information via its antenna 212 and receiver 214. In some examples, first UE device 102 receives the IUC information in a next available Physical Sidelink Control Channel (PSCCH) resource.

First UE device 102 utilizes its controller 216 to select, based at least partially on the IUC information, communication resources to be used for communication with second UE device 104. First UE device 102 and second UE device 104 communicate with each other utilizing the selected communication resources.

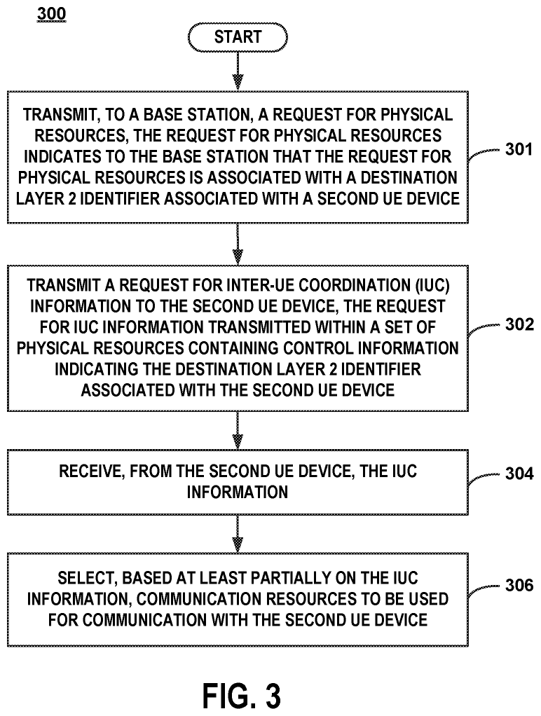

FIG. 3 is a flowchart of an example of a method in which a first user equipment (UE) device requests inter-UE coordination (IUC) information from a second UE device, where the request is transmitted within a set of physical resources containing control information indicating a Destination Layer 2 identifier (Destination L2 ID) associated with the second UE device. In some examples, method 300 begins at step 301 with transmitting, from first UE device 102 to base station 106, a request for physical resources. The request for physical resources indicates to base station 106 that the request for physical resources is associated with the Destination L2 ID associated with second UE device 104. Method 300 continues at step 302 with transmitting, from first UE device 102 to second UE device 104, a request for inter-UE coordination (IUC) information. The request for IUC information is transmitted within a set of physical resources containing control information indicating a Destination Layer 2 identifier (Destination L2 ID) associated with second UE device 104. At step 304, first UE device 102 receives, from second UE device 104, the IUC information. At step 306, first UE device 102 selects, based at least partially on the IUC information, communication resources to be used for communication with second UE device 104. In other examples, one or more of the steps of method 300 may be omitted, combined, performed in parallel, or performed in a different order than that described herein or shown in FIG. 3. In still further examples, additional steps may be added to method 300 that are not explicitly described in connection with the example shown in FIG. 3.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A first user equipment (UE) device comprising:
a transmitter configured to transmit a request for inter-UE coordination (IUC) information to a second UE device, the request for IUC information comprising control information indicating a Destination Layer 2 identifier (Destination L2 ID) associated with the second UE device;
a receiver configured to receive, from the second UE device, the IUC information; and
a controller configured to select, based at least partially on the IUC information, communication resources to be used for communication with the second UE device, wherein
the request for IUC information comprises a 1-bit signal.

2-3. (canceled)

4. The first UE device of claim 1, wherein
the transmitter is further configured to transmit the request for IUC information utilizing a set of communication resources dedicated to transmit requests for IUC information.

5. The first UE device of claim 1, wherein
the transmitter is further configured to transmit the request for IUC information over a Physical Sidelink Feedback Channel (PSFCH).

6. The first UE device of claim 1, wherein
the receiver is further configured to receive a message containing Physical Resource Block (PRB) index assignment information for one or more UE devices.

7. The first UE device of claim 1, wherein
the receiver is further configured to receive a message containing a Destination L2 ID for one or more UE devices.

8. The first UE device of claim 1, wherein
the receiver is further configured to receive the IUC information in a next available Physical Sidelink Control Channel (PSCCH) resource, which is selected from a coordination message resource pool.

9. The first UE device of claim 1, wherein
the transmitter is further configured to transmit the request for IUC information at least an integer number of slots before the first UE device intends to send a data transmission to the second UE device.

10. The first UE device of claim 9, wherein
the receiver is further configured to receive the integer number from a network.

11. The first UE device of claim 1, wherein
the transmitter is further configured to transmit, to a base station, a request for physical resources, the request for physical resources indicating that the request for physical resources is associated with the Destination L2 ID associated with the second UE device.

12. A first user equipment (UE) device comprising:
a receiver configured to receive a request for inter-UE coordination (IUC) information from a second UE device, the request for IUC information comprising control information indicating a Destination Layer 2 identifier (Destination L2 ID) associated with the first UE device; and
a transmitter configured to transmit, to the second UE device, the IUC information, the reception of the IUC information causing the second UE device to select, based at least partially on the IUC information, communication resources to be used for communication with the first UE device, wherein
the request for IUC information comprises a 1-bit signal.

13-14. (canceled)

15. The first UE device of claim 12, wherein
the receiver is further configured to receive the request for IUC information via a set of communication resources dedicated to transmit requests for IUC information.

16. The first UE device of claim 12, wherein
the receiver is further configured to receive the request for IUC information over a Physical Sidelink Feedback Channel (PSFCH).

17. The first UE device of claim 12, wherein
the transmitter is further configured to transmit the IUC information in a next available Physical Sidelink Control Channel (PSCCFI) resource, which is selected from a coordination message resource pool.

18. A method performed by a first user equipment (UE) device, the method comprising:
transmitting a request for inter-UE coordination (IUC) information to a second UE device, the request for IUC information comprising control information indicating a Destination Layer 2 identifier (Destination L2 ID) associated with the second UE device;
receiving, from the second UE device, the IUC information; and
selecting, based at least partially on the IUC information, communication resources to be used for communication with the second UE device, wherein
the request for IUC information comprises a 1-bit signal.

19. A non-transitory computer readable medium storing a computer program comprising computer-executable instructions which when executed by processing circuitry of a device causes the device to perform the method of claim 18.

20. A method performed by a first user equipment (UE) device, the method comprising:
receiving a request for inter-UE coordination (IUC) information from a second UE device, the request for IUC information comprising control information indicating a Destination Layer 2 identifier (Destination L2 ID) associated with the first UE device; and
transmitting, to the second UE device, the IUC information, the reception of the IUC information causing the second UE device to select, based at least partially on the IUC information, communication resources to be used for communication with the first UE device, wherein
the request for IUC information comprises a 1-bit signal.

21. A non-transitory computer readable medium storing a computer program comprising computer-executable instructions which when executed by processing circuitry of a device causes the device to perform the method of claim 20.
